(19) United States
(12) Patent Application Publication
(10) Pub. No.: US 2007/0064658 A1
(43) Pub. Date: Mar. 22, 2007

(54) Flexible and monolithic rake receiver

(76) Inventor: Qiuzhen Zou, La Jolla, CA (US)

Correspondence Address: DUANE MORRIS LLP, 101 WEST BROADWAY, SUITE 900, SAN DIEGO, CA, 92101-8285, US

(21) Appl. No.: 11/525,540

(22) Filed: Sep. 21, 2006

Related U.S. Application Data
(60) Provisional application No. 60/719,925, filed on Sep. 21, 2005.

(51) Int. Cl. H04B 7/216

(52) U.S. Cl. 370/335; 370/342

(57) ABSTRACT

A flexible and monolithic rake receiver apparatus, method, or computer-readable medium to decode a multi-path spread-spectrum signal to produce symbols. The rake receiver includes an input data double buffer, an interpolator, a correlation engine and a coherent accumulator. The input data double buffer collects input data during a current time-share period. The input data is interpolated and rotated, producing despread data and descrambled data. A coherent accumulation is performed resulting in symbols from the despread and descrambled data.

This application claims priority to U.S. Provisional Application No. 60/719,925 filed Sep. 21, 2005.

### BACKGROUND

1. Field of the Invention

Aspects of the present invention relate in general to wireless communication. Specifically, embodiments of the invention relate to an Application Specific Integrated Circuit (ASIC) architecture of a multi-mode wireless receiver that is capable of demodulating multiple wireless communication standards simultaneously on a highly configurable yet efficient hardware platform.

2. Description of Related Art

The field of wireless communication standards has grown increasingly complex. Commonly deployed systems are based on wireless standards including Code Division Multiple Access (CDMA), Time Division Synchronous Code Division Multiple Access (TD-SCDMA), Wideband CDMA (WCDMA), and Code Division Multiple Access 2000 (CDMA2000). Even more advanced technologies such as High-Speed Downlink Packet Access (HSDPA) and High-Speed Uplink Packet Access (HSUPA) are on the verge of being adopted and deployed as commercial systems.

Moreover, it has become increasingly important for wireless communication devices such as mobile phones, data access cards and modules, gaming devices, personal digital assistants, digital cameras, portable music players, and other portable devices to support multiple wireless communication standards at the same time, offering their users flexibility, mobility and ubiquitous accessibility.

Typically, individual hardware is dedicated to receive each type of code channels. The traditional approach of CDMA rake receivers is to instantiate an individual hardware slice for each received multi-path signal. Within each receiver hardware slice, hardware resources are allocated corresponding to the maximum number of code channels the receiver slice must handle. This results in an uneconomical realization of the receiver when it comes to supporting multi-mode wireless communication standards.

### SUMMARY

Embodiments of the invention include a rake receiver apparatus, method and computer-readable medium configured to decode symbols from received multi-path signals. The receiver includes an input data double buffer, an interpolator, a correlation engine and a coherent accumulator. The input data double buffer collects input data during a current time-share period. The input data is interpolated by the interpolator. The interpolated input data is received at the correlation engine and rotated, producing despread data and descrambled data. A coherent accumulation is performed by a coherent accumulator resulting in symbols from the despread and descrambled data.

### BRIEF DESCRIPTION OF THE DRAWINGS

FIG. 1 is a block diagram of a flexible CDMA rake receiver architecture embodiment, capable of demodulating various wireless received paths, and various number of spread spectrum code channels per received path.

FIGS. 2A-D illustrate alternate embodiments of the flexible CDMA rake receiver capable of handling a large number of wireless communication standards simultaneously.

### DETAILED DESCRIPTION

One aspect of the present invention includes the realization that architecture of a flexible Code Division Multiple Access (CDMA) rake receiver should be capable of demodulating various numbers of wireless received paths and various number of spread spectrum code channels per received path. In a Wideband CDMA embodiment, this approach offers a flexible, integrated, and low-cost rake receiver to perform demodulations for both WCDMA Release 99 and Release 5 High Speed Downlink Packet Access (HSDPA).

Embodiments of the present invention include an apparatus, method, and integrated circuit configured to receive input data from multiple spread spectrum channels to produce a decoded symbol.

The following ASIC architectures illustrate the concepts and implementation of embodiments of the present invention. The embodiments disclose an architecture of a multi-mode receiver supporting Wideband CDMA High-Speed Downlink Packet Access (HSDPA), High-Speed Uplink Packet Access (HSUPA), and the Global Positioning System (GPS). It is understood by those familiar with the art that other variations and alterations may equally apply without taking away from the invention. In addition to the above-mentioned standards and technologies, other wireless standards that may also be simultaneously supported by the disclosed embodiments include, but are not limited to: Time Division Multiple Access (TDMA), Global System for Mobile (GSM), General Packet Radio Service (GPRS), Enhanced Data rates for GSM Evolution (EDGE), the Institute of Electrical and Electronics Engineers (IEEE) 802.11 standards (“WiFi”), Worldwide Interoperability for Microwave Access (WiMAX), BlueTooth, any wireless spread-spectrum technologies, and other wireless networking communication standards known in the art.

Determining the Design Requirements

A radio transmission signal emitted over-the-air by a transmitter source (such as a base station or a satellite) typically travels through multiple radio propagation paths. Over each radio propagation path the radio signal is subject to various interference and distortion, and then the resulting noise-added signal arrives at a receiver at a different phase and time. In wireless communication systems such as WCDMA and HSDPA, to provide superior performance in terms of sensitivity and data throughput, a receiver must be capable of receiving most of these propagation paths (typical value:≧10) from each transmitter source. At any given time, a number of transmitter sources (typical value:≧8) in the neighboring area need to be received at same time. A separate set of propagation paths must be associated with each transmitter source.

For illustrative purposes, we define a receiver slice as a basic hardware unit that demodulates a set of code channels from one transmitter source to the receiver via one radio propagation path. For WCDMA, HSDPA and HSUPA, a large number of receiver slices are desired—possibly more than 80 relevant propagation paths. (Eighty is derived as the product of eight transmitter sources and ten propagation paths per transmitter source.)

When receiving GPS is considered, the number of simultaneous receiver slices grows even bigger since there are up to 12 GPS transmitter sources (satellites) possible to be received at any given time.

Within a radio propagation path that is assigned to a receiver slice, there are typically multiple information channels separated by channelization codes. These information channels are referred to as “code channels”. It is desired for a receiver slice to demodulate the following WCDMA code channels at same time:

1. 1 Primary Common Control Physical Channel (PCCPCH)

2. Up to 2 Secondary Common Control Physical Channels (SCCPCH's) from the serving base station.

3. Up to 3 Dedicated Physical Channels (DPCH's)

4. 1 Paging Indicator Channel (PICH)

5. 1 Access Indicator Channel (AICH)

6. 3 Primary Common Pilot Channels (PCPICH's)

If the reception of HSDPA is desired, the receiver slice must be capable of demodulating the following in addition to the WCDMA code channels:

1. 4 High Speed Shared Control Channels (HSSCCH's)

2. Up to 15 High Speed Physical Downlink Shared Channels (HSPDSCH's)

Further more, if the support of HSUPA is desired, the receiver slice must also demodulate the following channels in association with the uplink Enhanced Dedicated Channel (E-DCH), in addition to the WCDMA and HSDPA channels:

3. 1 E-DCH Absolute Grant Channel (E-AGCH)

4. 1 E-DCH Hybrid ARQ Indicator Channel (E-HICH)

5. 1 E-DCH Relative Grant Channel (E-RGCH)

Besides the receiver slices operating on WCDMA+HSDPA+HSUPA, other receiver slices are needed to demodulate code channels carried on GPS signals emitted from GPS satellites:

1. 3 C/A Codes (Clear Acquisition Code)

Consequently, a receiver slice carries various amount of workload, ranging from as simple as signal detection of GPS C/A code channels, to as complex as a simultaneous reception of about 30 possible code channels across WCDMA, HSDPA and HSUPA.

Within each code channel, typically Orthogonal Variable Spreading Factor (OVSF) codes are used to channelize information symbols. After channelization, each data symbol turns into a number of fragments (also known as, “chips”), and then the resulting chip sequence is further scrambled by a scrambling code sequence.

For each code channel, the receiver removes the effect of scrambling applied from the transmitter side (referred to as the “Descramble Operation”), and then reverses the channelization step by combining a number of relevant chips to reproduce the data symbol transmitted (referred to as the “Despread Operation”).

### Embodiments

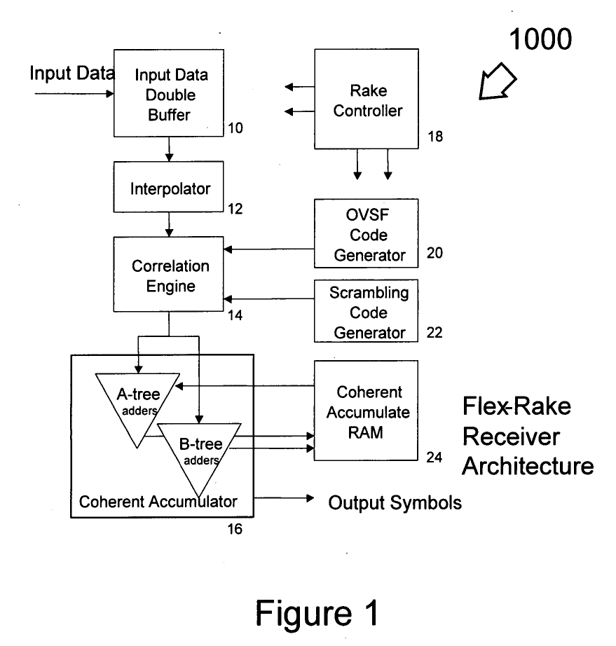

Operation of embodiments of the present invention may be illustrated by example. FIG. 1 depicts a flexible and monolithic rake receiver 1000 introduced to handle both WCDMA Release 99 and WCDMA Release 5 code channels simultaneously, in accordance with an embodiment of the present invention. It is understood, by those familiar with the art, that wireless communication standards selected are for illustrative purposes only, and that other embodiments may be adapted to other wireless communication standards without departing from the present invention.

At the heart of the receiver 1000 is a correlation engine 14 that performs the scrambling code removal and Orthogonal Variable Spreading Factor code despread. The correlation engine 14 is time-shared among up to 16 multi-paths, and various number of code channels per multi-path. The time allocated per multi-path corresponds to the actual number of code channels to demodulate for that multi-path. The time to process all multi-paths is the summation of the actual number of code channels of the actual number of multi-paths. During a time period when all code channels of all multi-paths have been processed, the rake receiver is shut down to conserve power. Therefore the receiver 1000 is characterized by its ultimate flexibility: the flexible number of multi-paths, the flexible number and type of code channels for each multi-path, and the proportional power consumption corresponding to the actual needs.

As shown in FIG. 1, the input data enters an Input Data Double Buffer 10. The double-buffered output is interpolated by the Interpolator 12 to reach eighth chip resolution, and then sent to the Correlation Engine 14. The Correlation Engine 14 removes the scrambling effect and OVSF code, with the result to be summed up in the Coherent Accumulator 16. The Coherent Accumulator outputs complete output symbols for further processing 16.

The Rake Controller 18 provides the scheduling information as the sorting order of the multi-paths and code channels within the multi-path to time-share the Correlation Engine 14.

In some embodiments, the clock rate is chosen according the spreading rate. For example, the clock rate may be chosen at 38.4 MHz, corresponding to 10 times over a 3.84 Mcps spreading rate. The time-share period is chosen as 15 spreading chips, or 150 clock cycles.

The scrambling code removal, OVSF code despread, and following Symbol Demodulator and Combiner are capable of processing one code channel per cycle. Therefore, the total number of code channels across all multi-paths is 150. Obviously, by choosing a higher clock rate or a longer time-share period, more code channels may be accommodated. For all practical purposes, the combination of 10× clock rate and 15-chip time-share period is a good engineering tradeoff.

The following is one example of a time-sharing configuration of the rake receiver 1000:

Multi-path 0,3,6,12,15: disabled

Multi-path 1,7,11,13: 4 code channels, tracking P-CCPCH of a neighboring base station.

Multi-path 2,4,8,9,10: 24 code channels, tracking HS-SCCH, HS-PDSCH and DPCHs.

Multi-path 5,14: 6 code channels, tracking DPCHs

Thus, the total number of code channels for this configuration is:
4×4+5×24+2×6=148<150.

As illustrated in above example, the listing order, the number of active multi-path receiver slices, and the number and type of code channels per receiver slice are flexible.

In a 15-chip time-share period, the input data buffer 10 presents the input data arrived during a previous time-share period to the rest of the receiver 1000. At the same time, the input data buffer 10 collects the input data arrived during the current time-share period for presentations in the next period. A double-buffer scheme may be used in some embodiments.

In some embodiments, instead of using a shift register to propagate input data through an array of parallel registers are addressed individually to capture the corresponding input data. For each input data that arrives, only one register is clocked and enabled to store the data. This approach lowers the power consumption, when compared to the shift register approach where all registers are updated per input data.

The received signal streams into the rake receiver at twice the spreading-chip-rate (7.68 Mcps), allowing the receiver to intentionally offset the timing by half-spreading-chip earlier or late (corresponding to CPICH-E and CPICH-L), in order to obtain time synchronization.

In some embodiments, the input data double buffer comprises 15×2×2×2=120 register elements, with each element holding a complex (in-phase and quadrature) received signal. As for double buffering, two banks of 60 registers alternate the role of capturing input data and presenting the captured data every time-share period.

While the input data comes in at twice the spreading-chip rate, each multi-path requires timing resolution of up to the eighth spreading chip. Within each 15-chip time-share window, the 30 input data presented are interpolated to eighth chip resolution by an interpolator 12.

Due to changing radio propagation channels, a multi-path could move in time. Gradually, the eighth chip timing resolution is adjusted based on the detected multi-path movements. When a number of eighth-chip steps are taken to cause the multi-path timing to cross integer spreading chip boundary, depending the direction of crossing, we add a 16th chip data (a timing advance) or remove the 15th chip (a timing retard) from the current time-share period, to that specific multi-path, to compensate for the effect of changing path timing.

For each code channel, the interpolator 12 outputs 14 to 16 parallel chip data at a specific eighth chip resolution to the following Correlation Engine 14.

A Scrambling Code Generator 22 is any circuitry, block or function that produces parallel chips of complex scrambling sequence to the Correlation Engine every time-share period. In our example implementation, the Scrambling Code Generator 22 produces 16 parallel chips.

An OVSF code generator 20 any circuitry, block or function that produces parallel chips of OVSF sequence to the Correlation Engine every time-share period. In our example implementation, the OVSF code generator 20 produces 16 parallel chips.

The correlation engine 14 may be any circuitry, block, or function that takes the interpolated input data from the Interpolator 12, and then removes the scrambling effect. Specifically, based on each complex chip of scrambling sequence presented from the Scrambling Code Generator 22, the Correlation Engine 14 performs a complex multiplication intended to rotate the phase of the complex interpolated input data.

After the scrambling removal, the OVSF sequence is removed from the descrambled input data, resulting in 14 to 16 parallel chip data for further processing in the Coherent Accumulator 16.

For each code channel, the Coherent Accumulator 16 sums up the data that were spread over an OVSF code sequence during the transmission process from the base station. The summation result is denoted as the output symbol, to be further processed.

The time-share period boundary is chosen arbitrarily. Depending on the specific multi-path timing and the spreading factor (SF, also known as the length of OVSF code sequence), each time-share period could contain signal chips corresponding to partial, one, or more output symbols.

The Coherent Accumulator 16 scans across the 14 to 16 chips of data presented from Correlation Engine 14. It contains 2 accumulation trees 160, namely, A-tree 160A and B-tree 160B. The A-tree 160A is responsible for adding up data chips up to the first chip of a new output symbol (if any) in the time-share period. The B-tree 160B adds up the rest of data chips.

If the last data chip in a time-share period is not the last chip of an output symbol, either A-tree 160A or the B-tree 160B output is stored in Coherent Accumulate RAM 24 so the partially accumulated symbol value is kept for next time-share period. Specifically, A-tree 160A output is saved in Coherent Accumulate RAM 24 if there is no first chip of a new symbol in the current time-share period. Otherwise, B-tree 160B output is saved.

If the first data chip in a time-share period is not the first chip of an output symbol, the Coherent Accumulate RAM is read to retrieve the previously stored partially accumulated symbol, and then add it to the A-tree.

In the case of SF=4 and SF=8, a 15-chip time-share period may contain multiple complete symbols. The big A-tree 160A and B-tree 160B are re-configured to several smaller A and B accumulation trees 160, to produce these output symbols.

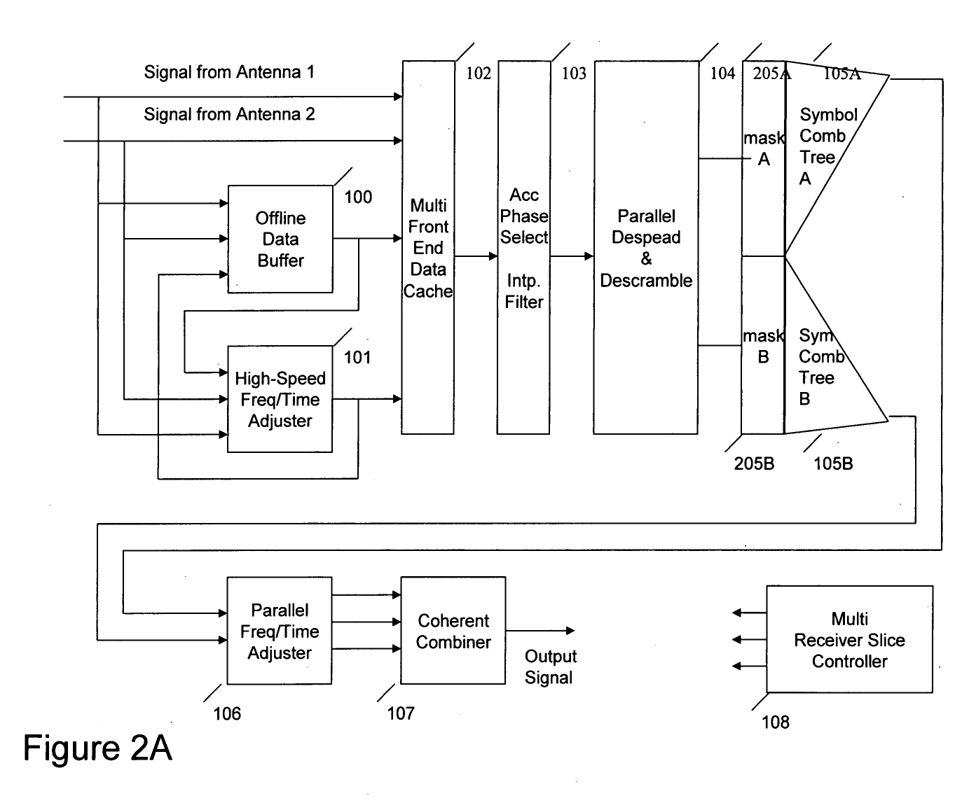

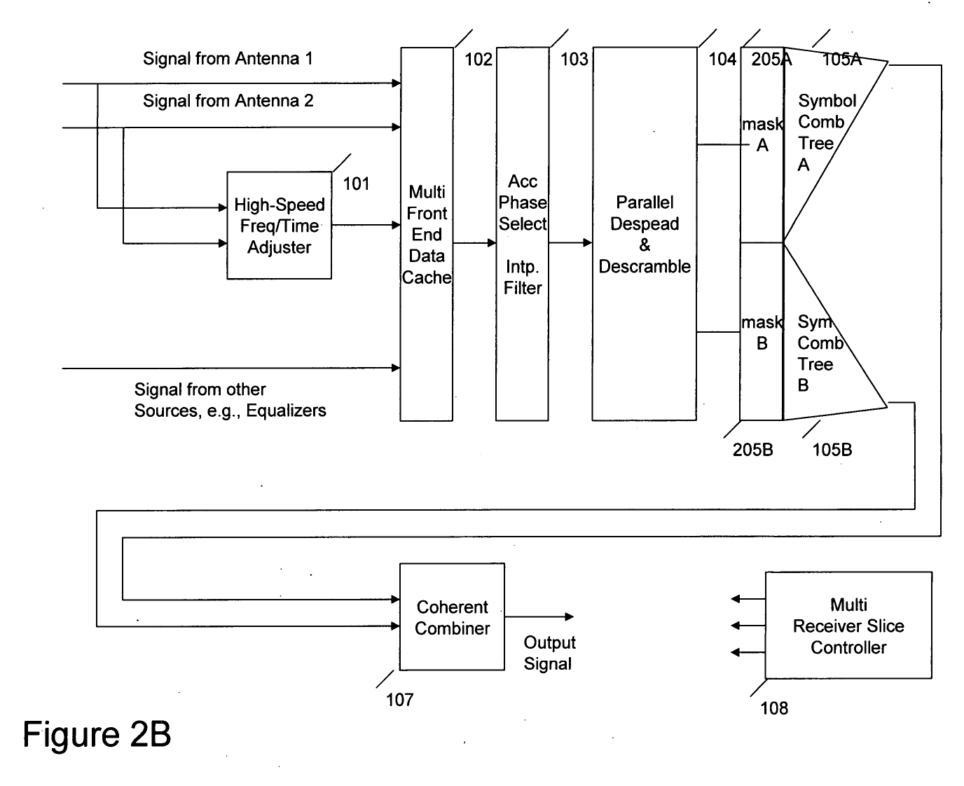

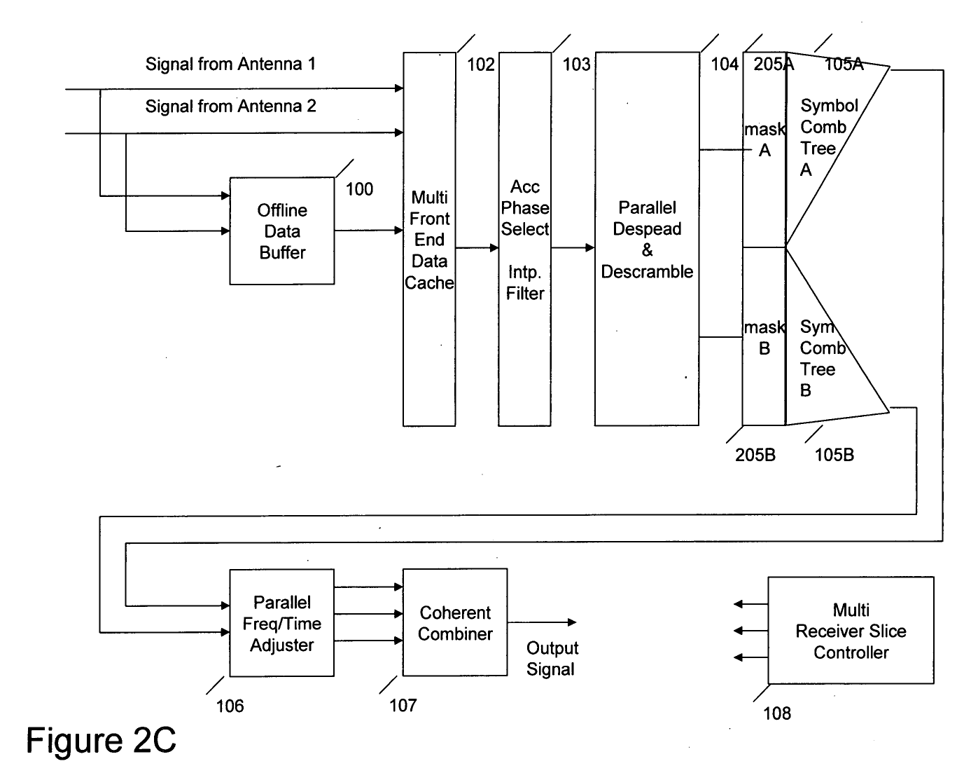

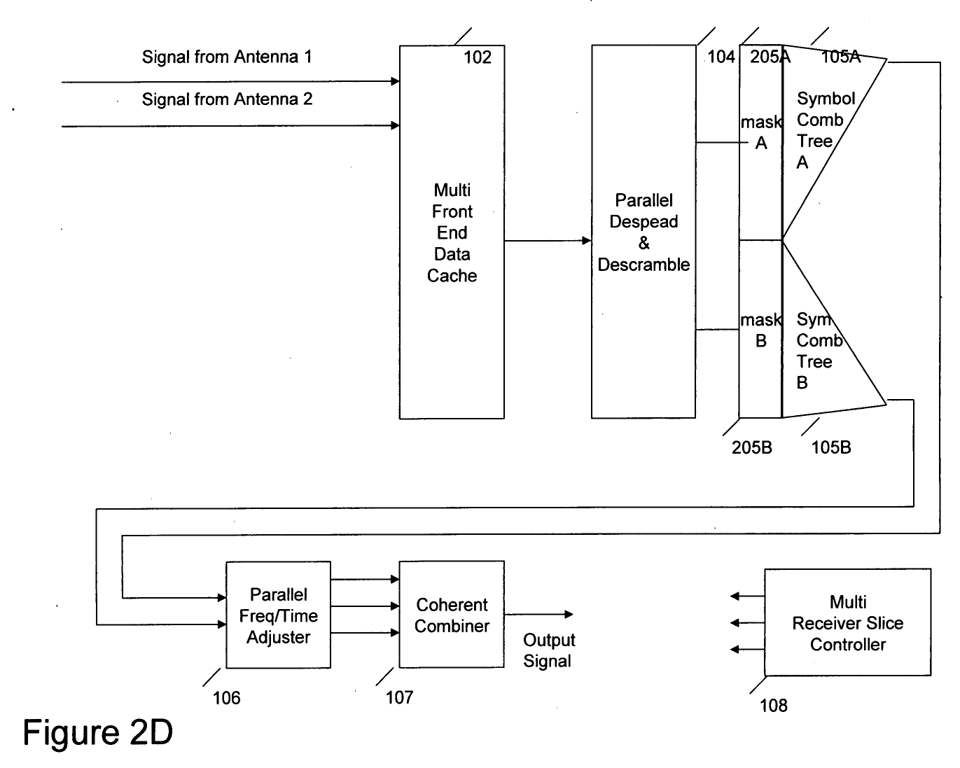

FIGS. 2A-D illustrate alternate flexible and monolithic rake receiver embodiments introduced to handle a large number of wireless communication standards simultaneously, in accordance with an embodiment of the present invention. These standards include, but are not limited to WCDMA, HSDPA, HSUPA, TD-SCDMA, and GPS. It is understood, by those familiar with the art, that wireless communication standards selected are for illustrative purposes only, and that other embodiments may be adapted to other wireless communication standards without departing from the present invention.

This receiver architecture includes the following circuit elements, in various configurations:

1. Offline Data Buffer 100,

2. High-Speed Frequency/Timing Adjuster 101,

3. Multiple Front-end Data Cache 102,

4. Accurate Phase Selection Interpolation Filter 103,

5. Parallel Despread and Descrambler 104,

6. Arbitrary Symbol Combining Trees 105,

7. Parallel Frequency/Timing Adjuster 106,

8. Coherent Combiner 107, and

9. Variable-Cycle Multiple Receiver Slices Controller 108.

This architecture is shown in various configurations and forms in FIGS. 2A-D.

Multiple receiver slices time-share a single hardware engine adopting the above architecture. The demodulation requirement per receiver slice varies based on the type of wireless communication standards, and the number of code channels to receive. Each receiver slice occupies a variable number of cycles over a fixed time period based on its decoding needs. During each time period after all receiver slices have completed their processing, the hardware engine is shut down to conserve power.

In summary, the receiver may be characterized through its ultimate flexibility by supporting a number of wireless communication standards, with a number of transmitter sources per standard, as well as a number of radio propagation paths per transmitter, and a number of code channels per path, all over a single hardware engine. The power consumption is proportional to the actual workload.

An optional buffer, namely Offline Data Buffer 100, is placed in front to provide sample storage. This is especially useful for PICH Demodulation and Decoding in WCDMA, GPS Signal Acquisition, as well as inter-frequency and/or inter-RAT (Radio Access Technology) signal scans.

The input base band data is captured in the Offline Data Buffer 100 sequentially in a steady order. Subsequently, when the corresponding receiver slice get its share of time over the hardware engine, the relevant data is read out of the Offline Data Buffer in arbitrary order and/or in bursts. This allows incoming base band reception at a constant rate, while the processing circuitries are running at arbitrary speed.

The receiver as a whole typically uses an oscillator tuned to a particular radio carrier frequency. However, due to relative movement, a signal traversing through different radio propagation paths could have different frequency offset with reference to the frequency the receiver has turned to. —Speed Frequency/Timing Adjuster 101 may be any unit that corrects the frequency. For example, GPS Satellites are flying across the sky at rather high speed, thus creating rather large frequency Doppler that must be corrected.

A High-Speed Frequency/Timing Adjuster 101 is used to correct relatively large amount of frequency/timing offset over the incoming stream—making the subsequent signal processing much more efficient.

The incoming received data either enters the High-Speed Frequency/Timing Adjuster 101 directly or is fetched out of the Offline Data Buffer 100.

A noteworthy point of the inclusion of Timing Adjustment in the Adjuster is that, not only is the frequency offset corrected, but also compensate for the timing offset accumulated due to the sampling frequency offset.

A number of component caches are instantiated within Multiple Front-end Data Cache 102. Each component cache runs independently and aims to provide intermediate storage for different received streams, where each stream could be,

1. captured on different receive antenna;

2. output from Front-End Channel Equalizer 109;

3. output from High-Speed Frequency/Timing Adjuster 101 using different frequency/timing adjuster setting.

These streams come out of their respective sources and then are multiplexed. Each receiver slice that is operating in its allocated time chooses one or more streams to perform demodulation.

Another important characteristic of the Multiple Front-end Data Cache 102 is that each component cache is double buffered. This allows, at any given time, for a copy of a component cache that is stable across the entire time period over which multiple receiver slices are time-sharing. In addition, since the data is captured in the cache one-by-one, the cache consumes minimum power as compared to a shift-register based single buffer that prior arts have been based on.

In the interest of saving storage elements in both the Offline Data Buffer 100 and Multiple Front-end Data Cache 102, the lowest possible sampling rate is kept (typically Nyquist sampling frequency). However if a finer data output phase is desired, an Accurate Phase Selection Interpolation Filter 103 interpolates to a programmable data sampling offset.

A Parallel Despread and Descrambler 104 processes a number of data chips simultaneously. The Parallel Despread and Descrambler 104 takes input from Accurate Phase Selection Interpolation Filter 103. The outputs are presented to the Arbitrary Symbol Combining Trees.

In order to support GPS along with WCDMA, HSDPA, HSUPA, and etc., the Parallel Despead and Descrambler 104 has a built-in C/A Code Generator in addition to the Primary Scrambling Code Generator.

When multiple data chips are despread and descrambled by the Parallel Despread and Descrambler 104, the parallel outputs can contain zero, one, or more symbols.

In FIGS. 2A-D, the incoming despread and descrambled data are presented simultaneously to two sets of Arbitrary Symbol Combining Trees, namely 105A and 105B. Each combining tree operates on combining the incoming data, subject to control of a corresponding mask, namely Mask 205A and Mask 205B. Given the N-element parallel data, there are the following possibilities:

1. The entire N-chip data is part of a data symbol. In this case either Mask 205A or Mask 205B is set to select all elements. The chosen combining tree forwards the combining result for the trailing circuit units.

2. The entire N-chip data contains chips from two data symbol. In this case Mask 205A is set to select the group of data chips that corresponds to the first data symbol which is the earlier arrival data, and Mask 205B is set to select the remaining data chips.

3. The entire N-chip data contains chips from more than two data symbols. In this case an extra clock cycle is inserted for each complete data symbol contained within the N-chip span. As a result, within each clock cycle instructions defined in 1 and 2 are followed.

In some embodiments, at the output of Arbitrary Symbol Combining Trees 105, an optional Parallel Frequency/Timing Adjuster 106 may be subject to multiple frequency adjustments. This is especially important during signal detection and measurement, where multiple frequency-offset-hypotheses are tried in order to find the right amount of frequency offset to apply on the incoming data stream.

A Coherent Combiner 107 performs data chips combining beyond the size of Parallel Despread and Descrambler 104. Its entries always contain partially despread results per receiver slice and per code channel.

A Variable-Cycle Multiple Receiver Slices Controller 108 may serve as the governing entity for the entire hardware engine. It issues various reset and enable pulses to each circuit unit. It schedules the sequence of code channel demodulation within each receiver slice.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A flexible and monolithic rate receiver comprising:
an input data double buffer configured to collect input data during a current time-share period;
an interpolator configured to interpolate the input data received from the input data double buffer to produce interpolated input data;
a correlation engine configured to rotate a phase of the interpolated input data to produce despread data and descrambled data; and
a coherent accumulator configured to coherently accumulate the despread data and the descrambled data to produce at least one symbol as an output signal.

2. The receiver of claim 1, wherein the correlation engine performs an Orthogonal Variable Spreading Factor (OVSF) code despread.

3. The receiver of claim 2, wherein the correlation engine is time-shared among multiple paths.

4. The receiver of claim 3, wherein the Interpolator interpolates to reach eighth chip resolution.

5. The receiver of claim 4, further comprising.
a rake controller configured to provide scheduling information as to the sorting order of multi-paths and code channels within the multi-path to time-share the correlation engine.

6. The receiver of claim 5, further comprising.
a scrambling code generator configured to produce parallel chips of complex scrambling sequence to the correlation engine during the current time-share period.

7. The receiver of claim 6, further comprising.
an Orthogonal Variable Spreading Factor code generator configured to produce parallel chips of Orthogonal Variable Spreading Factor code to the correlation engine during the current time-share period.

8. The receiver of claim 7, wherein the coherent accumulator contains at least one accumulation tree, the accumulation tree configured to add up data chips to produce the at least one symbol.

9. The receiver of claim 7, wherein the coherent accumulator contains at least two accumulation trees, the first accumulation tree configured to add up data chips to produce the at least one symbol, the second configured to add up any remaining data chips.

10. The receiver of claim 9, wherein the input data is Wideband Code Division Multiple Access, High-Speed Downlink Packet Access (HSDPA), High-Speed Uplink Packet Access (HSUPA), Global Positioning System (GPS), Global System for Mobile (GSM), General Packet Radio Service (GPRS), or Enhanced Data rates for GSM Evolution (EDGE) data.

11. A method comprising:
collecting input data during a current time-share period to produce collected input data;
interpolating the collected input data to produce interpolated input data;
rotating a phase of the interpolated input data to produce despread data and descrambled data; and
coherently accumulating the despread data and the descrambled data to produce at least one symbol as an output signal.

12. The method of claim 11, wherein the despread data is created via an Orthogonal Variable Spreading Factor (OVSF) code despread.

13. The method of claim 12, wherein the interpolating the collected input data reaches eighth chip resolution.

14. The method of claim 13, further comprising:
providing scheduling information as to the sorting order of multi-paths and code channels within the phase rotation of the interpolated input data.

15. The method of claim 14, further comprising:
producing parallel chips of complex scrambling sequence to the phase rotation of the interpolated input data during the current time-share period.

16. The method of claim 15, further comprising:
producing parallel chips of Orthogonal Variable Spreading Factor code to the phase rotation of the interpolated input data during the current time-share period.

17. The method of claim 16, wherein the coherently accumulating further comprises adding up data chips to produce the at least one symbol.

18. The receiver of claim 17, wherein the input data is Wideband Code Division Multiple Access, High-Speed Downlink Packet Access (HSDPA), High-Speed Uplink Packet Access (HSUPA), Global Positioning System (GPS), Global System for Mobile (GSM), General Packet Radio Service (GPRS), or Enhanced Data rates for GSM Evolution (EDGE) data.

19. A computer-readable medium, encoded with data and instructions, such that when executed by a computing device, the instructions cause the device to:
collect input data during a current time-share period to produce collected input data;
interpolate the collected input data to produce interpolated input data;
rotate a phase of the interpolated input data to produce despread data and descrambled data; and
coherently accumulate the despread data and the descrambled data to produce at least one symbol as an output signal.

20. The computer-readable medium of claim 19, wherein the despread data is created via an Orthogonal Variable Spreading Factor (OVSF) code despread.
